(19) United States
(12) Patent Application Publication
(10) Pub. No.: US 2025/0330793 A1
(43) Pub. Date: Oct. 23, 2025

(54) MANAGING ROAMING OF CLIENT DEVICES IN A WIRELESS NETWORK

(71) Applicant: HEWLETT PACKARD ENTERPRISE DEVELOPMENT LP, Spring, TX (US)

(72) Inventors: Mohd Shahnawaz Siraj, San Jose, CA (US); Andre Beaudin, Montreal (CA); Omar El Ferkouss, St. Laurent (CA); Sachin Ganu, San Jose, CA (US)

(21) Appl. No.: 18/643,776

(22) Filed: Apr. 23, 2024

(51) Int. Cl. H04W 8/08; H04W 12/06; H04W 24/02

(52) U.S. Cl. CPC H04W 8/08; H04W 12/068; H04W 24/02

(57) ABSTRACT

An example method and a network device are presented that identifies the right set of roaming targets including one or more non-radiofrequency (RF) neighbor access points (APs) to which roaming provisioning credentials may be provided in advance of the client devices roaming in their network coverage areas. In some examples, the network device may use a machine learning model to identify a first set of roaming targets comprising one or more non-RF neighbor APs corresponding to a source AP of a client device in the network infrastructure. Then the network device may determine first roaming provisioning credentials for the first set of roaming targets, and transmit the first roaming provisioning credentials to the first set of roaming targets in advance of the client device roaming to any of the first set of roaming targets.

### BACKGROUND

Roaming in Wireless Fidelity (Wi-Fi) is a process in which a mobile client device seamlessly switches from one wireless networking device such as an access point (AP) to another AP as its user moves from one location to another in a network infrastructure. When a device moves out of the range of a currently associated AP (referred to as a source AP), it searches for and associates with the next available AP with the strongest signal. The AP to which the client device is newly associated is referred to as a target AP. The roaming process occurs automatically and is designed to provide uninterrupted connectivity for the user's online activities. More specifically, to prevent interruption of the user's online activities (e.g., webpage browsing, video/audio streaming, video/audio conferencing, etc.) while the mobile device roams from the source AP to the target AP, the client device needs to successfully associate with the target AP. To enable such fast associations with client devices, the candidate target APs are generally provisioned with roaming credentials.

In such a roaming process, the identification of the right set of target APs may be challenging which may cause delays in the client device's reassociations and interrupt the wireless network connectivity of the client devices. For instance, the lack of understanding of the movements of the client devices may impact the identification of the right set of target APs. The non-identification of the right set of target wireless networking devices may cause unavailability of the roaming credentials required to successfully authenticate the client device, leading to delays in establishing wireless connectivity for the client device. This in-turn may interrupt the user's online activities causing an unpleasant user experience.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts an example networked system in which various of the examples presented herein may be implemented.

FIG. 2 depicts example interactions among the components shown in the networked system of FIG. 1.

FIG. 3 depicts a block diagram of an example cloud computing system hosting a network device for managing the roaming of client devices.

FIG. 4 depicts a flowchart of an example method for managing the roaming of client devices in a network infrastructure.

FIG. 5 depicts a flowchart of another example method for managing the roaming of client devices in a network infrastructure.

FIG. 6 depicts a block diagram of an example computing system.

The Figures are not exhaustive and do not limit the present disclosure to the precise form disclosed.

### DETAILED DESCRIPTION

The target access points (APs) may use roaming credentials to enable faster roaming of the client devices. The roaming credentials may include encrypted keys such as an R0 key and an R1 key. R0 key is used for security during the initial mobility domain association for a client device. The R0 key may be derived from a Pairwise Master Key (PMK) and is used to protect the authentication and association frames during the initial association of the client with an AP within the mobility domain. R1 key is used for security during the reassociation of the client device within the same mobility domain. The R1 key may be derived from the PMK and is used to protect the reassociation frames when a client roams from one access point to another within the same network.

In a known fast-roaming solution, a cloud-hosted key management service pre-populates R1 keys to immediate radiofrequency (RF) neighbor APs of the source AP under the assumption that the client device will roam to such immediate RF neighbor APs. The immediate RF neighbor APs for the host AP may refer to any AP that is located within a predefined radiofrequency (RF) range. The RF range may be determined based on an RF signal strength at the host AP. In the known fast-roaming solution, after a client device is associated with the source AP, the source AP provides the R0 key of the client device to the key management service. Then, the key management service obtains a list of immediate RF neighbor APs of the source AP and calculates R1 keys (PMK-R1) for these immediate RF neighbor APs. After the R1 keys are calculated, the key management service distributes the R1 keys to all of the immediate RF neighbor APs in advance. Accordingly, when the client device moves into the range of one of the immediate RF neighbor APs, such immediate RF neighbor APs can successfully authenticate the client device as it already has the R1 for the reassociation of the client device.

This may work well and enable seamless roaming with minimal disruption to applications like voice and video. However, challenges arise when client devices roam to APs that are not immediate RF neighbor APs of their respective source APs. For example, users may move between floors, such as by taking an elevator to attend a meeting or move to areas like a cafeteria served by other APs that are not neighbor APs to the source AP. In other implementations such as university deployments, a user might close their laptop and move to another classroom, served by an AP that is not a neighboring of the source AP of the client device. As such, the existing fast-roaming solution lacks the ability to predict such roaming scenarios impacting roaming efficiency. Therefore, there exists a need to enable smoother transitions in unpredictable mobility situations, ensuring a consistently reliable and uninterrupted network experience for users.

To address the aforementioned challenges, in examples consistent with the teachings of this disclosure, a method and a network device are presented that identifies the right set of roaming targets to which roaming provisioning credentials may be provided in advance of the client devices roaming in their network coverage areas. In particular, the proposed network device leverages historical roaming patterns within a specific deployment to learn, for a given AP, the roaming behavior of its client devices by way of training a Machine Learning (ML) model, and to use such ML model to infer future roaming events. In addition, in some examples, the proposed network device may also identify another set of roaming targets that include immediate RF neighbor APs of the source AP. This way, the proposed network device may be able to identify immediate RF neighbor APs as well as non-RF neighbor APs, if any, and provide them with useful roaming provisioning credentials to enable fast roaming of the client devices. For example, by constructing the ML model based on past roaming behavior and patterns, the R1 key can be intelligently pre-populated on the immediate RF neighbor APs and non-RF neighbor APs of the source AP that are candidates for future roaming events.

In some examples, the network device may access an ML model built based on a dataset characterizing past roaming of client devices among APs in a network infrastructure. The network device may then use this ML model to identify a first set of roaming targets that includes one or more non-RF neighbor APs corresponding to the home of a client device in the network infrastructure. Then, for each of the first set of roaming targets, the network device may determine respective roaming provisioning credentials and transmit such roaming provisioning credentials to each of the first set of roaming targets in advance of the client device roaming to any of the first set of roaming targets. In some examples, the network device may also identify a second set of roaming targets that may include the immediate RF neighbor APs of the source AP. The network device may also determine roaming provisioning credentials for the second set of roaming targets, and transmit them to each of the second set of roaming targets in advance of the client device roaming to any of the second set of roaming targets.

As will be appreciated, the proposed network device may enable seamless roaming and enhance user experience as the ML model may be able to predict the roaming targets that are not immediate RF neighbor APs to which the client device is connected. With the proposed technique, the roaming credentials, for example, the R1 keys may be pre-populated to such non-RF neighbor APs which may then use these keys for faster authentication. Due to the faster overall reassociation, the service interruptions to the client devices may be minimized leading to an overall better user experience.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

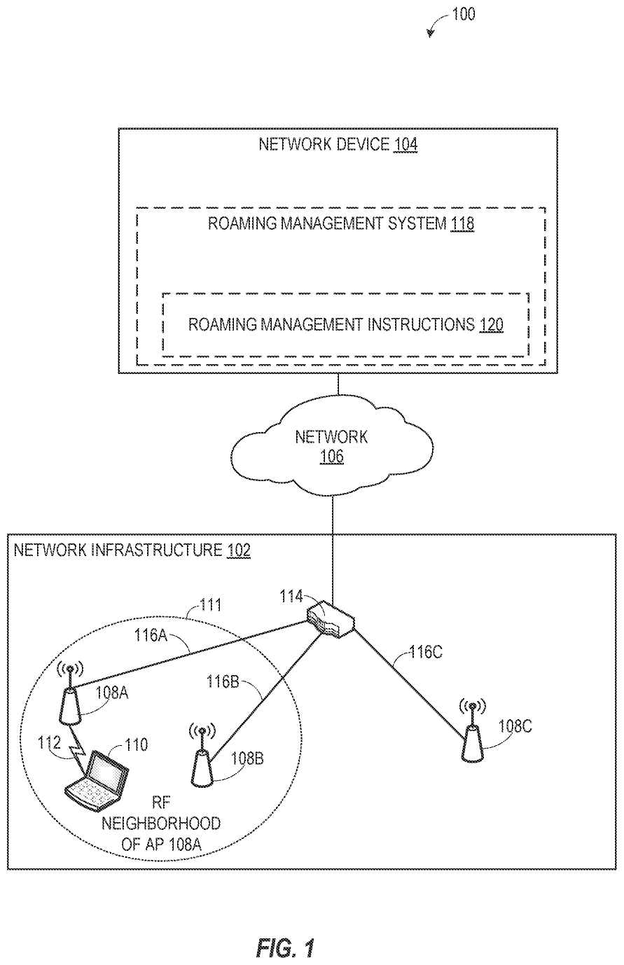

Before describing examples of the disclosed systems and methods in detail, it is useful to describe an example network installation with which these systems and methods might be implemented in various applications. FIG. 1 depicts an example networked system 100 in which various of the examples presented herein may be implemented. The networked system 100 may be implemented for any setup, for example, in a home setup or an organization, such as a business, educational institution, governmental entity, healthcare facility, or other organization. The networked system 100 may include a network infrastructure 102, or both the network infrastructure 102 and a network device 104. In FIG. 1, although the network device 104 is shown external to the network infrastructure 102, in some examples, the network device 104 may be a part of the network infrastructure 102. In certain examples, the networking devices (e.g., access points, controllers, routers, etc.) deployed in the network infrastructure 102 may be configured to implement the functionalities of the network device 104.

The network infrastructure 102 may be a small-scale network of devices or a large-scale network of devices. The small-scale network of devices may be a home network, for example. The large-scale network of devices may be an organization, university, public utility space (e.g., mall, airport, railway station, bus station, stadium, etc.), or office network hosting a large number of network devices, for example. The network infrastructure 102 may span across more than one site, for example, a room, a floor of a building, a building, or any other space that can host network devices. The network infrastructure 102 may be a private network, such as a network that may include security and access controls to restrict access to authorized users of the private network.

The network infrastructure 102 may include several devices that communicate with each other and/or with any external device or system outside the network infrastructure 102. In the example implementation depicted in FIG. 1, the network infrastructure 102 is shown to include wireless networking devices, such as, access points APs 108A, 108B, and 108C (hereinafter collectively referred to as APs 108A-108C); and one or more client devices, for example, a client device 110. Further, in some examples, the network infrastructure 102 may optionally include a controller 114 that is in communication with an external network 106. It is to be noted that the examples presented herein are not limited by the specifics (e.g., types and counts) of the devices depicted in FIG. 1. In some examples, the APs 108A-108C, the client device 110, and the controller 114 may be configured to communicate other devices using wireless communication techniques specified in one or more Institute of Electrical and Electronics Engineers (IEEE) 802.11 standard specifications.

The wireless networking devices, for example, the APs 108A-108C may act as a point of access to a local network established in the network infrastructure 102 and/or the external network 106 for any client devices in the network infrastructure 102. For example, in the implementation depicted in FIG. 1A, the client device 110 is shown as connected to the AP 108A via a wireless communication link 112. Accordingly, the client device 110 may communicate with any other devices (inside the network infrastructure 102 or outside the network infrastructure 102) via the AP 108A. The wireless communication link 112 may be established in compliance with any of the IEEE 802.11 Standards. In the description hereinafter, the AP to which the client device 110 is currently connected, i.e., the AP 108A, may be referred to as a source AP for the client device 110.

A wireless networking device, for example, any of the APs 108A-108C, may be a combination of hardware, software, and/or firmware that is configured to provide wireless network connectivity to the client device 110. The wireless networking devices may communicate with the client devices in accordance with one or more IEEE 802.11 standard specifications. In some examples, the APs 108A-108C may be implemented with one or more radios to help the APs 108A-108C communicate with the respective client devices and other wireless-capable devices. Each radio may operate on a respective range of radio frequency ranges, referred to as a Wi-Fi band, for example, the 2.4 GHz Wi-Fi band, 5 GHz Wi-Fi band, the 6 GHz Wi-Fi band, and so on.

The network 106 may be a public or private network, such as the Internet, or another communication network to allow connectivity between the network infrastructure 102 and the network device 104. The network 106 may include third-party telecommunication lines, such as phone lines, broadcast coaxial cables, fiber optic cables, satellite communications, cellular communications, and the like. In some examples, the network 106 may include any number of intermediate network devices, such as switches, routers, gateways, servers, and/or controllers, which are not directly part of the network infrastructure 102 but that facilitate communication between the various parts of the network infrastructure 102, and between the network infrastructure 102 and any other network-connected entities.

The APs 108A, 108B, and 108C may communicate with the controller 114 over respective connections, for example, the connections 116A, 116B, and 116C, which may include wired and/or wireless interfaces. The controller 114 may provide communication with the network 106 for the network infrastructure 102, though it may not be the only point of communication with the network 106 for the network infrastructure 102. In some examples, the controller 114 may communicate with the network 106 through a router (not shown). In other implementations, the controller 114 may provide router functionality to the devices in the network infrastructure 102. In some examples, the controller 114 may be a wireless local area network (WLAN) controller. The controller 114 may be operable to configure and manage network devices, such as at the network infrastructure 102, and may also manage network devices at other remote sites, if any, within the network infrastructure 102. The controller 114 may be operable to configure and/or manage switches, routers, access points, and/or client devices connected to a network. The controller 114 may itself be, or provide the functionality of, an AP.

The examples of client device 110 may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, and the like.

Some client devices may be portable and can be moved from one location to another in the network infrastructure 102. As will be understood, each of the APs 108A-108C may provide wireless connectivity in a respective limited range, also referred to as a network coverage area. In the network coverage area of a given AP, the strength of signals from the given AP may be above a predefined value. Accordingly, in its network coverage area, the given AP may provide good wireless connectivity to any client device. However, when a client device moves outside of the network coverage area or reaches closer to the boundary of the network coverage area of its source AP the signal strength from the source AP may decrease, and the client device may start to look out for other APs that can provide better wireless connectivity and initiate roaming. Roaming in Wi-Fi is a process in which a mobile client device seamlessly switches from one wireless networking device (e.g., its source AP) to another wireless networking device (e.g., roaming target) as its user moves from one location to another in a wireless network.

In compliance with the Wi-Fi Standards, the APs 108A-108C may use the R0 or R1 keys to enable secure associations of the client devices. In particular, the R0 key may be used for security during the initial association for a client device in a given mobility domain. The mobility domain may be a collection of APs that form a continuous RF space. In the example implementation of FIG. 1, the APs deployed in the network infrastructure 102 such as the APs 108A, 108B, and 108C may define a continuous RF space and thus form a mobility domain. In one example, the APs in the network infrastructure 102 may be arranged such that the network infrastructure 102 may be a single mobility domain. Accordingly, when the client device 110 connects for the very first time in the mobility domain, for example, with the AP 108A, the AP 108A may use the R0 key to protect the authentication and association frames during the initial association of the client device 110 within the mobility domain. The other APs (e.g., the APs 108B and 108C) may use the R1 key for security during the reassociation of the client device 110.

To enable faster roaming, generally, the APs in the RF neighborhood (hereinafter referred to as immediate RF neighbors) of the source APs may receive the R1 key corresponding to the client devices connected to the source AP in advance. In particular, for a given AP, the immediate RF neighbors are the APs at which the received signal strength from the given AP is greater than a predefined threshold value. For example, in the implementation of FIG. 1, the AP 108B is an immediate RF neighbor of the source AP 108A as it is within the RF neighborhood 111 of the source AP 108A. On the other hand, the AP 108C is a non-RF neighbor for the source AP 108A. For illustration purposes, the RF neighborhood 111 is marked with a dotted outline representing an RF boundary in which the received signal strength from the given AP 108A may be greater than the predefined threshold value.

In some cases, the movement of the client devices in a given mobility domain may be abrupt and/or random. For instance, client devices may roam to APs that are not immediate RF neighbors of their source AP. For example, users may move between floors, such as by taking an elevator to attend a meeting or move to areas like a cafeteria served by other APs that are not immediate RF neighbors to the source AP. In other implementations such as university deployments, a user might close their laptop and move to another classroom, served by an AP that is not a neighboring of the source AP of the client device. The conventional solution may not prepopulate the useful roaming provisioning credentials to such non-RF neighbors.

To that end, the network device 104 may aid certain APs that are potential roaming targets with necessary roaming provisioning credentials to enable fast roaming even in cases when the AP to which the client device has roamed is not an immediate RF neighbor of its source AP. The network device 104 may be deployed in a public, private, or hybrid cloud outside the network infrastructure 102. In some examples, the network device 104 may be implemented as one or more computing systems, for example, computers, controllers, servers, or storage systems. In certain examples, the network device 104 may be an electronic device having a hardware processing resource, such as one or more central processing units (CPUs), semiconductor-based microprocessors, and/or other hardware devices suitable for retrieval and execution of instructions (e.g., roaming management instructions 120). In certain other examples, the network device 104 may be implemented as a software resource, such as a software application, a virtual machine (VM), a container, a containerized application, or a pod. In some examples, the network device 104 may be implemented as a service running on a “cloud computing” environment or as a “software as a service” (SaaS). The network device 104 and/or the functionalities implemented via the network device 104 may be offered as a stand-alone product/service or a packaged solution that can be utilized on a one-time full product/solution purchase or pay-per-use basis. In certain other examples, not shown in FIG. 1, the network device 104 may be deployed within the network infrastructure 102. In such an implementation, the network device 104 may be connected to controller 114 or the APs 108A-108C. In some other examples, the controller 114 may itself be configured to implement the functionalities of the network device 104.

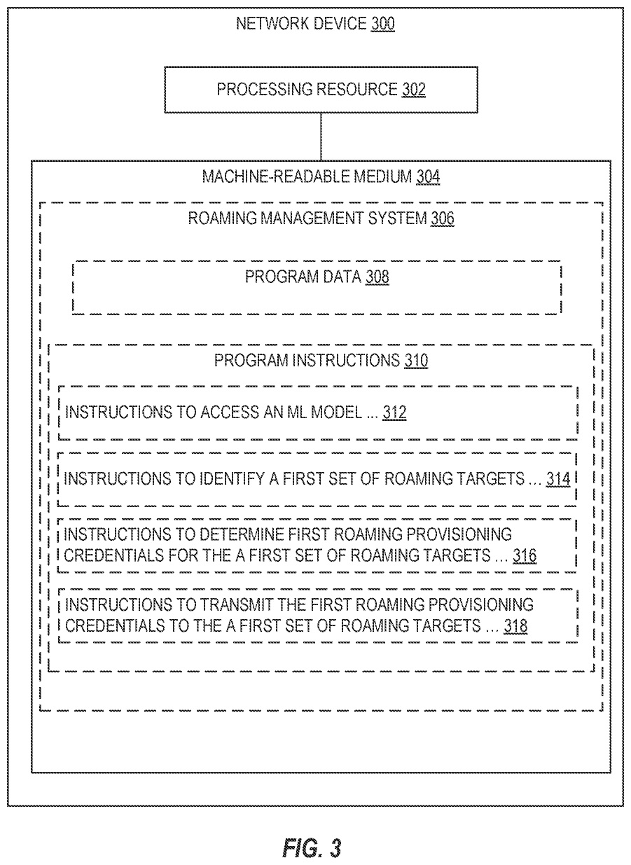

In accordance with the examples presented herein, the network device 104 may host a roaming management system 118 by way of a processing resource executing the roaming management instructions 120 stored in a machine-readable medium of the network device 104. For illustration purposes, the roaming management system 118 and the roaming management instructions 120 are represented by the dashed outline as they represent digital entities which may be in the form of data and/or instructions that are executable by a physical processing resource, for example, a processor. By way of executing the roaming management instructions 120, the roaming management system 118 may identify the right set of roaming targets to which roaming credentials may be provided in advance of the client devices roaming to any of such roaming targets. In particular, the proposed network device 104 leverages a machine learning (ML) model built based on historical roaming patterns within the network infrastructure 102 to infer future roaming events in the network infrastructure 102. In particular, the roaming management system 118 may identify a set of roaming targets comprising non-RF neighbors, if any, to which the client device may roam and provision such non-RF neighbors with the useful roaming provisioning credentials in advance to enable fast roaming of the client devices. For example, by constructing the ML model based on past roaming behavior and patterns, the R1 key can be intelligently pre-populated to the non-RF neighbors, for example, the AP 108C. Additional details about an example network device and an example roaming management system are described in conjunction with a block diagram of FIG. 3.

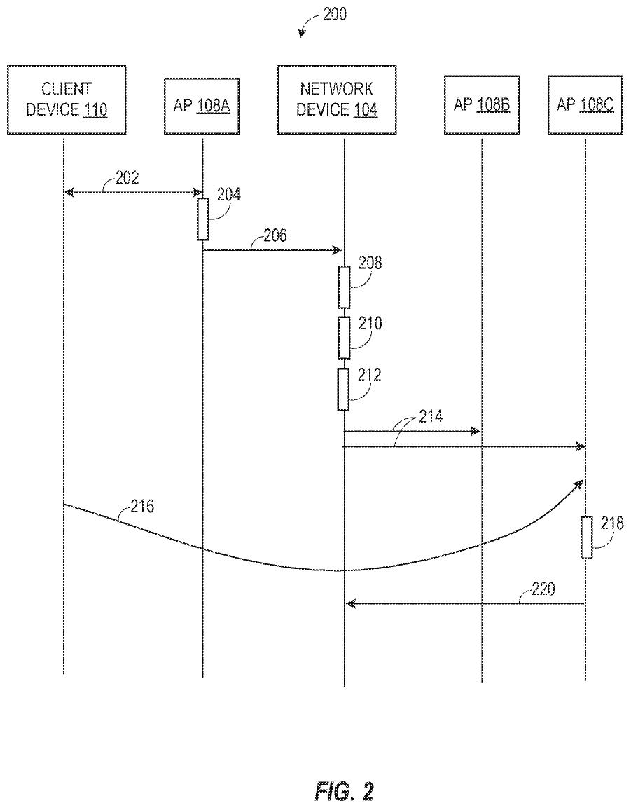

An example roaming scenario in the networked system 100 is described in conjunction with a message flow diagram of FIG. 2. In particular, a message flow diagram 200 depicted in FIG. 2 shows an example sequence of events and communication between various components in the networked system 100.

During sequence 202, the client device 110 initiates an association with the AP 108A by sending a connection request to the AP 108A. The association at sequence 202 may be the client device's first association in the mobility domain of the network infrastructure 102. Upon successful authentication by the AP 108A, the client device 110 be associated with the AP 108A. To authenticate the client device 110, the AP 108A derives an R0 key associated with the client using a Pairwise Master Key (PMK). Upon successful authentication of the client device 110, the AP 108A may encrypt the R0 key at sequence 204. Further, at sequence 206, the AP 108A may send a key update message to the network device 104. In some examples, the key update message may specify the encrypted R0 key and radius attributes such as a Virtual Local Area Network (VLAN) identifier for the client device 110.

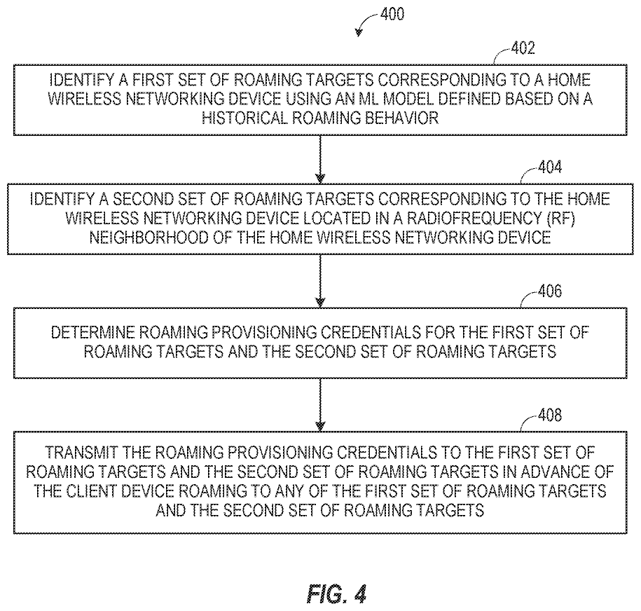

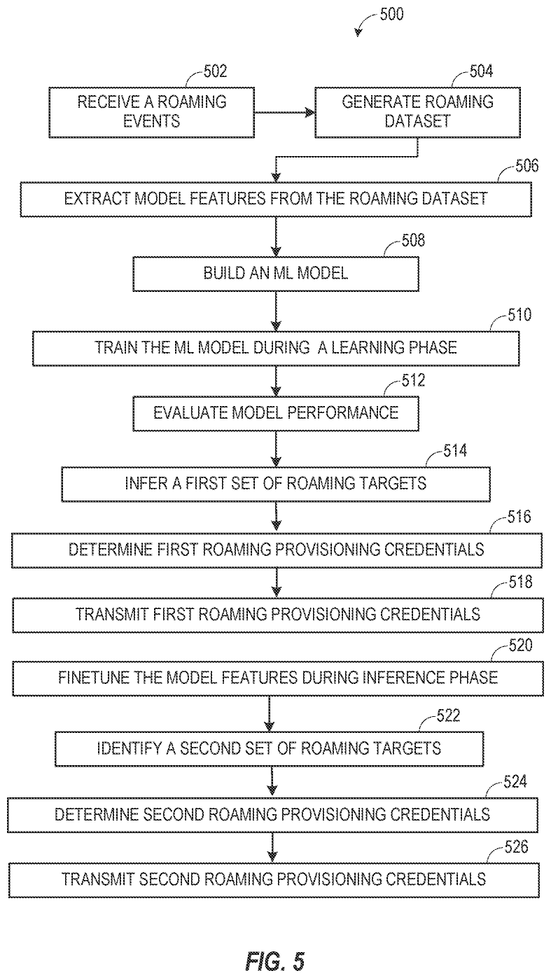

Further, at sequence 208, the network device 104 may update a key store (e.g., a key cache) by storing the R0 key reported by the AP 108A. In some examples, the network device 104 may also update other attributes such as the VLAN identifier in the respective data store in the network device 104. Furthermore, at sequence 210, the network device 104 may identify roaming targets for the client device 110. In one example, the network device 104 may determine roaming targets that may include the immediate RF neighbor APs or non-RF neighbor APs. In one example, the network device may store a list of the RF neighbor APs of each of the APs 108A-108C in an RF neighbor data and fetch such data when needed. For each of the APs 108A-108C, the network device 104 may determine respective the RF neighbor APs based on wireless signal strength. Also, the network device 104 may identify the non-RF neighbor APs based on the historical roaming behavior of client devices in the network infrastructure 102. In particular, the network device 104 may use one or more ML models developed based on the learning of past roaming events to infer the non-RF neighbor APs. The Additional details about how the network device 104 may identify the roaming targets are described in conjunction with the methods described in FIGS. 4 and 5.

Moreover, at sequence 212, the network device 104 may determine roaming provisioning credentials (e.g., R1 keys) for each of the roaming targets identified at sequence 210. The Additional details about how the network device 104 may identify the determine the roaming provisioning credentials roaming targets are described in conjunction with the methods described in FIGS. 4 and 5. After the roaming provisioning credentials are determined, the network device 104, at sequence 214, may transmit the roaming provisioning credentials to respective roaming targets. For instance, the roaming provisioning credentials may be sent to each of the RF neighbor AP(s) (e.g., the AP 108B) and non-RF neighbor AP(s) (e.g., the AP 108C) that are identified as the roaming targets. Accordingly, not only the immediate RF neighbor APs but also the non-RF neighbor APs that are identified as the roaming targets will receive the roaming provisioning credentials needed for client devices' reassociation.

At sequence 216, the client device 110 may move into the network coverage area of the AP 108C and initiate the roaming process by sending a reassociation request. The sequence 216 may represent a physical movement of the client device 110 into the network coverage area of the AP 108C. As depicted in FIG. 1, the AP 108C is not an immediate RF neighbor of the AP 108A. But, as the network device 104 had identified the AP 108C as a potential roaming target due to the machine learning of the past roaming events, the AP 108C has already been supplied with the roaming provisioning credentials (e.g., R1 keys) corresponding to the client device 110. Accordingly, at sequence 218, the AP 108C can also quickly authenticate the client device 110 using the respective R1 key and negotiate a roaming session. In particular, during this reassociation process, the AP 108C may establish a roaming session with the AP 108A (e.g., the source AP for the client device 110) via intermediate networking devices such as a network switch (not shown) or the controller 114. For example, the AP 108C may send the session request to the intermediate networking device, which in turn communicates the session request to the AP 108A. The AP 108A may then send a session response to the AP 108C. Upon receiving the session response from AP 108A, the AP 108C may complete the reassociation of the client device 110. At sequence 220, the AP 108C may notify the network device 104 of the successful authentication and association of the client device 110 with the AP 108C.

As will be appreciated, the network device 104 may also identify roaming targets corresponding to the new source AP (i.e., AP 108C) and pre-populate the R1 keys on them to enable future fast roaming of the client devices associated with the AP 108C.

Referring now to FIG. 3, a block diagram of an example network device 300 is presented. The network device 300 of FIG. 3 may be an example representative of the network device 104 of FIG. 1. In certain examples, the network device 300 may be implemented as a controller, such as, the controller 114 in the network infrastructure 102 of FIG. 1. In particular, the network device 300 is configured to manage roaming of the client devices within a network infrastructure, for example, the network infrastructure 102 of FIG. 1. More particularly, the network device 300 is configured to pre-populate the roaming provisioning credentials on a right set of roaming targets in advance of the client devices roaming thereto to enable fast roaming. In some examples, to enable such a distribution of the roaming provisioning credentials, the network device 300 implements a roaming management system 306. For illustration purposes, the roaming management system 306 and items inside the roaming management system 306 are represented by the dashed outline as they represent digital entities which may be in the form of data and/or instructions that are executable by a physical processing resource, for example, the processing resource 302.

The network device 300 may include a processing resource 302 and/or a machine-readable storage medium 304 for the network device 300 to execute several operations as will be described in the greater details below.

The processing resource 302 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 304, or combinations thereof. In one example, the processing resource 302 may fetch, decode, and execute the instructions stored in the machine-readable storage medium 304 to manage the roaming of the client devices. As an alternative or in addition to executing the instructions, the processing resource 302 may include at least one integrated circuit (IC), control logic, electronic circuits, or combinations thereof that include a number of electronic components for performing the functionalities intended to be performed by the network device 300.

The machine-readable storage medium 304 may be non-transitory and is alternatively referred to as a non-transitory machine-readable storage medium that does not encompass transitory propagating signals. The machine-readable storage medium 304 may be any electronic, magnetic, optical, or another type of storage device that may store data and/or executable instructions. Examples of the machine-readable storage medium 304 may include RAM, NVRAM, EEPROM, a storage drive (e.g., SSD or HDD), a flash memory, and the like. The machine-readable storage medium 304 may be encoded with the roaming management system 306 which aids in managing the roaming of the client devices from one AP to another AP in the network infrastructure. The roaming management system 306 includes program data 308 and program instructions 310 to manage the roaming of the client devices.

The program data 308 may store variety of data that may be received, used, and/or generated by the processing resource 302 as the processing resource 302 executes the program instructions 310. By way of example, the program data 308 include information about roaming events, a roaming dataset, ML models, roaming provisioning credentials, information about roaming targets including RF neighbors AP and non-RF neighbor APs, and/or training dataset. Each of these different types of data may be stored in a common datastore or a respective individual datastore in the program data 308. In certain other examples, the one or more types of data may be combined and stored in a combined datastore. In one example, the processing resource 302 may store roaming events received from APs (e.g., APs 108A-108C) in the program data 308. Further, the processing resource 302 may store the roaming dataset generated based on the roaming events in the program data 308. Furthermore, the processing resource 302 may store, in the program data 308, one or more ML models that the processing resource 302 may train and use to infer various roaming targets. Moreover, the processing resource 302 may store roaming provisioning credentials, such as, R1 keys in the program data 308. Further, the processing resource 302 may store information about RF neighbor APs for each of the APs deployed in the network infrastructure in the program data 308. Additionally, the processing resource 302 may store, in the program data 308, a list of roaming targets (e.g., non-RF neighbor APs that are identified as roaming targets) for the APs in the network infrastructure. Furthermore, the processing resource 302 may store a training dataset comprising a plurality of training roaming events in the program data 308.

In accordance with examples consistent with the present disclosure, the network device 300 may execute the roaming management system 306, by way of the processing resource 302 executing the program instructions 310, to manage the roaming of the client devices from one AP to another AP in the network infrastructure. In particular, in some examples, the processing resource 302 may execute one or more of the program instructions 310 to perform the method steps described in conjunction with FIGS. 4 and 5. For example, the program instructions 310 may include instructions 312, 314, 316, and 318. In particular, the instructions 312 when executed by the processing resource 302 may cause the processing resource 302 to access from the program data 308, an ML model built based on a dataset characterizing past roaming of client devices among APs in the network infrastructure. Further, the instructions 314, when executed by the processing resource 302, may cause the processing resource 302 to identify using the ML model, a first set of roaming targets comprising one or more non-RF neighbor APs corresponding to a source AP. Furthermore, the instructions 316, when executed by the processing resource 302, may cause the processing resource 302 to determine first roaming provisioning credentials for the first set of roaming targets. Moreover, the instructions 318, when executed by the processing resource 302, may cause the processing resource 302 to transmit the first roaming provisioning credentials to the first set of roaming targets in advance of the client device roaming to any of the first set of roaming targets. Although not shown, in some examples, the machine-readable storage medium 304 may be encoded with certain additional executable instructions to perform any other operations performed by the network device 300, without limiting the scope of the present disclosure.

Turning now to FIGS. 4 and 5, flowcharts of example methods for managing the roaming of client devices are presented. The steps shown in FIGS. 4 and 5 may be performed by any suitable device, such as a network device 104 or the controller 114 shown in FIG. 1, or the network device 300 of FIG. 3. In some examples, the suitable device may include a processing resource suitable for retrieval and execution of instructions stored in a machine-readable storage medium. The processing resource and the machine-readable storage medium may be example representatives of the processing resource 302 and the machine-readable storage medium 304 of the network device 300. As an alternative or in addition to retrieving and executing instructions, the processing resource may include one or more electronic circuits that include electronic components for performing the functionality of one or more instructions, such as an FPGA, ASIC, or other electronic circuits.

FIG. 4 depicts an example method 400 for managing the roaming of client devices (e.g., the client device 110 FIG. 1) in a network infrastructure (e.g., the network infrastructure 102 of FIG. 1).

At step 402, a network device (e.g., the network device 104 of FIG. 1 or the network device 300 of FIG. 3) may access a machine learning (ML) model. The machine learning model is built based on historical roaming patterns of the client devices in the network infrastructure. More particularly, the ML model was developed based on a dataset, hereinafter referred to as a roaming dataset, characterizing past roaming of client devices among the APs (e.g., the APs 108A-108C) in the network infrastructure. For instance, each of the APs may report roaming events to the network device. The roaming event, for a given client device, may specify information associated with its source AP, target AP, a timestamp of the roaming, and the like. For example, the roaming event may specify, one or more of an identifier of a respective source AP, an identifier of a target AP, a timestamp of the roaming event, a Media Access Control (MAC) address of the given client device, or a device type of the given client device. The identifiers of the source AP and the target AP may be one or more of the respective device names, Internet Protocol (IP) addresses, or MAC addresses of the source AP and the target AP. In one example, the device type of the client device may be representative of an operating system (e.g., ‘Android’ or ‘iOS’) executing on the client device. Syntax 1 presented below depicts an example roaming event specifying one or more of the above-listed information.
{
“Client MAC”: “11:22:33:44:55:66”,
“Device Type”: “iOS”,
“Source AP”: “AP1”,
“Target AP”: “AP2”,
“Time of Day”: “11 AM”
}

### Syntax 1—Example Roaming Event

The roaming event depicted in the Syntax-1 represents a roaming scenario where a client device having the MAC address 11:22:33:44:55:66 and device type-“iOS” roamed at 11 AM from a source AP (having device name AP1) to a target AP (having device name AP2). Likewise, the network device may receive many such roaming events from the APs deployed in the network infrastructure periodically or on a real-time basis. The roaming dataset may be a collection of all such roaming events reported by the APs deployed in the network infrastructure. Additional details regarding the ML model are described in conjunction with the method of FIG. 5.

Further, at step 404, the network device may identify a first set of roaming targets using the ML model. In particular, the network device may use the ML model to infer the first set of roaming targets for the client devices associated with the source AP. For example, for a given time of the day, the network device may predict one or more non-RF neighbor APs corresponding to a source AP as the first set of roaming targets. For example, based on the learning from the roaming dataset, the ML model may infer that a given client device that is currently associated with AP1 may likely move to AP3 which is not an immediate RF neighbor of AP1. Accordingly, the AP3 may be included in the first set of roaming targets.

Furthermore, at step 406, the network device may determine first roaming provisioning credentials for the first set of roaming targets. In particular, a roaming provisioning credential for a given roaming target of the first set of roaming targets may include a target encryption key, for example, an R1 key in compliance with the IEEE) 802.11r Specification. The network device may calculate the R1 key, for a given roaming target of the first set of roaming targets, based on a client encryption key corresponding to the client device and respective Basic Service Set Identifiers (BSSIDs) of the given roaming target. The client encryption key may be the R0 key that was used during the first association of the client device in the mobility domain.

Once the first roaming provisioning credentials are determined, the network device, at step 408, may transmit the first roaming provisioning credentials to the first set of roaming targets in advance of the client device roaming to any of the first set of roaming targets. Such a prior transmission of the R1 keys to the non-RF neighbor APs may allow the non-RF neighbor APs to quickly authenticate the client device, thereby providing seamless network connectivity and improving the user experience.

Referring now to FIG. 5, a flowchart of another example method 500 for managing the roaming of client devices (e.g., the client device 110 FIG. 1) in a network infrastructure (e.g., the network infrastructure 102 of FIG. 1) is presented. The method 500 of FIG. 5 may include certain additional steps and or information compared to the method 400 of FIG. 4. Also, certain details of the steps that are already described in FIG. 4 are not repeated herein for the sake of brevity.

At step 502, the network device may receive roaming events from APs deployed in the network infrastructure. Each of the APs deployed in the network infrastructure may report roaming events to the network device. In some examples, the APs may report the roaming events to the network device on a real-time basis (i.e., immediately upon detecting that a client device has left its association with an AP and connected to another AP). In some other examples, the APs may accumulate the roaming events over a predefined duration and send a collection of such roaming events to the network device. In certain examples, the APs may send the roaming events to the network device periodically, on demand from the network device, or after a certain number of roaming events have been detected. The roaming event (see Syntax 1, for example), for a given client device, may specify information associated with its source AP, target AP, a timestamp of the roaming, and the like. In some examples, the network device may store the roaming events received from the APs in a program data such as the program data 308 shown in FIG. 3.

Further, at step 504, the network device may generate a roaming dataset by combining and processing the roaming events reported by the APs. In some examples, the network device may access the roaming event datastore and process the roaming data by filtering out the irrelevant fields and keeping useful fields that may help in building the ML model. In certain examples, the network device may request the roaming dataset from an external source. In such cases, the APs may report the roaming events to such external source and the external source may be responsible for generating the roaming dataset from the reported roaming events. In some examples, the network device may store the roaming dataset in a program data such as the program data 308 shown in FIG. 3.

Once the roaming dataset is generated or obtained, the network device, at step 506, may extract model features from the roaming dataset. The selection of the model features may depend on what information the ML model is designed to infer and what parameters can help infer such information. In the present example, the ML model may be used to infer, for a given AP, potential roaming targets, in particular, the non-RF neighbor APs to which the client devices from the given AP may roam. Accordingly, in one example, the model features such as a first device identifier of a source AP (hereinafter referred to as “source AP identifier”), a second device identifier of a target AP (“target AP identifier”), a roaming event time, a third device identifier of the client device (hereinafter referred as “client identifier”), and a client device type (hereinafter referred to as “client device type”) may be extracted. As these model features include details about the client device (e.g., the third device identifier of the client device and the client device type), the resultant ML model may be trained to infer future roaming events for each client device. In particular, such model features may help the network device finetune the resultant ML model for a given device type (e.g., IOS, Android, etc.).

In some other examples, while selecting the model features, the information specific to the client devices may omitted to build a client device-agnostic ML model. In such an implementation, the model feature may include the source AP identifier, the target AP identifier, and the roaming event time. As these model features do not include details about the client devices, the resultant ML model may be trained to infer future roaming events for APs. Accordingly, such an ML model may be used to infer potential roaming targets with respect to a given AP, which is to find to what all APs the client devices associated with the given AP may roam to.

After the model features are extracted, the network device, at step 508, may build an ML model. To build the ML model, the network device may be configured to select a candidate ML model from a variety of models, such as supervised learning models, unsupervised learning models, reinforcement learning models, neural networks, decision trees, support vector machines, long short-term memory (LSTM), etc. It may be noted that the examples presented herein are not limited with respect to the types of ML models. The use of any suitable type of ML model is envisioned within the purview of the present disclosure. The network device may store the selected ML model in a program data such as the program data 308 shown in FIG. 3.

After the ML model is selected, the network device, at step 510, may train the selected ML model during a learning phase. The learning phase may be a period after the ML model has been selected and before the ML model is deployed for a real-time application. In this learning phase, the model features may be tuned using the training dataset to generate inferences. In some examples, the network device may access the training dataset useful for training the ML model from a program data such as the program data 308 shown in FIG. 3. In one example, the training dataset store may be preconfigured with a sample training dataset. In another example, the network device may receive a new training dataset and/or update the already stored sample training dataset during the learning phase.

The training dataset may include training roaming events. In an example where the ML model to be built is client agnostic, a training roaming event may not include client device-specific details. For example, Syntax-2 presented below represents a first example training roaming event without the client device-specific details.
{
“Source AP”: “AP1”,
“Target AP”: “AP2”,//Dependent or Target Variable
“Time of Day”: “Time”
}

### Syntax 2—First Example Training Roaming Event

In another example where the ML model is specific to the client device, a training roaming event is designed to include client device-specific details. For example, Syntax-2 presented below represents one such example training roaming event without the client device-specific details.
{
“Client MAC”: “11:22:33:44:55:66”,
“Device Type”: “iOS”, //Or Android
“Source AP”: “AP1”,
“Target AP”: “AP2”, //Dependent or Target Variable
“Time of Day”: “Time”
}

### Syntax 3—First Example Training Roaming Event

In the learning phase, the model features are tuned to learn the patterns of roaming behavior based on dozens or hundreds of such training roaming events. This tuning of the model features during the learning phase is referred to as a first finetuning of the model features.

Once the model parameters are tuned, the network device, at step 512, may evaluate the model performance. For example, the network device may test the model's performance for metrics, such as accuracy, precision, recall, F1 score, and the like. In some examples, if any improvement in the model performance is needed, the network device may again perform the model training (see step 510). In some examples, if the model performance is not satisfactory, the network device may return to the model-building step (see step 508) and select a new model, which may be trained (at step 510) to achieve the desired performance.

Once the ML model is trained, the learning phase ends, and an inference phase starts wherein the network device may start using the ML model for real-time applications. For example, at step 514, the network device may infer a first set of roaming targets including one or more non-RF neighbor APs based on the time of the day and using the ML model. In particular, the network device may identify, using the ML model, a first set of roaming targets comprising potential non-RF neighbor APs for a given source AP. For example, for a given time of the day, the network device may predict one or more non-RF neighbor APs corresponding to a source AP as the first set of roaming targets. In one example, for the network infrastructure of FIG. 1 and based on past roaming of client devices, using the ML model, the network device may identify the AP 108C as the non-RF neighbor AP of the source AP 108A and include it in the first set of roaming targets. The network device may store information (e.g., a MAC address, AP name, IP address, etc.) about the first set of roaming targets in the program data 308 shown in FIG. 3.

Furthermore, at step 516, the network device may determine first roaming provisioning credentials for the first set of roaming targets. In particular, a roaming provisioning credential for a given roaming target of the first set of roaming targets may include a target encryption key, for example, an R1 key in compliance with the IEEE) 802.11r Specification. The network device may calculate the R1 key, for a given roaming target of the first set of roaming targets, based on a client encryption key corresponding to the client device and respective Basic Service Set Identifiers (BSSIDs) of the given roaming target. The client encryption key may be the R0 key that was used during the first association of the client device in the mobility domain. In some examples, the network device may store the first roaming provisioning credentials, such as the, R1 keys for the first set of roaming targets, in a program data such as the program data 308 shown in FIG. 3.

Once the first roaming provisioning credentials are determined, the network device, at step 518, may transmit the first roaming provisioning credentials to the first set of roaming targets in advance of the client device roaming to any of the first set of roaming targets. Such a prior transmission of the R1 keys to the non-RF neighbor APs may allow the non-RF neighbor APs to quickly authenticate the client device, thereby providing seamless network connectivity and improving the user experience.

Moreover, in some examples, at step 520, the network device may again fine-tune the model features based on roaming events reported during the inference phase. Such a finetuning of the model features during the inference phase is also referred to as a second finetuning of the model features and may be performed using a similar technique as described in conjunction with step 510.

Additionally, at step 522, in some examples, the network device may identify a second set of roaming targets comprising one or more RF neighbor APs of the source AP. In one example, the APs in the network infrastructure may report a list of its RF neighbors to the network device. In another example, the network device may obtain a list of its RF neighbors for any given AP from an external entity. The external entity may be a service or a device that may identify and maintain a list of RF neighbor APs for the APs deployed in the network infrastructure. In yet another example, the network device itself may identify the RF neighbor APs for the APs deployed in the network infrastructure based on received signal strength. For instance, the network device may select one or more APs having Received Signal Strength Indicator (RSSI) values at a source AP greater than a threshold value as RF neighbor APs of the source AP, and identify such RF neighbor APs as the second set of roaming targets. In one example, the network device maintains information (e.g., a MAC address, AP name, IP address, etc.) a list of all RF neighbor APs (reported by APs, obtained from an external entity, or self-identified) in a program data such as the program data 308 shown in FIG. 3.

Further, the network device, at step 524, may determine second roaming provisioning credentials for the second set of roaming targets. In particular, the second roaming provisioning credentials may include R1 keys for each of the second set of roaming targets that may be determined based on a client encryption key corresponding to the client device and respective Basic Service Set Identifiers (BSSIDs) of the second set of roaming targets. In some examples, the network device may store the second roaming provisioning credentials, such as the, R1 keys for the second set of roaming targets, in a program data such as the program data 308 shown in FIG. 3.

Once the second roaming provisioning credentials are determined, the network device, at step 526, may transmit the second roaming provisioning credentials to the second set of roaming targets in advance of the client device roaming to any of the second set of roaming targets. Such a prior transmission of the R1 keys to the RF neighbor APs may allow the RF neighbor APs to quickly authenticate the client device, thereby providing seamless network connectivity and improving the user experience.

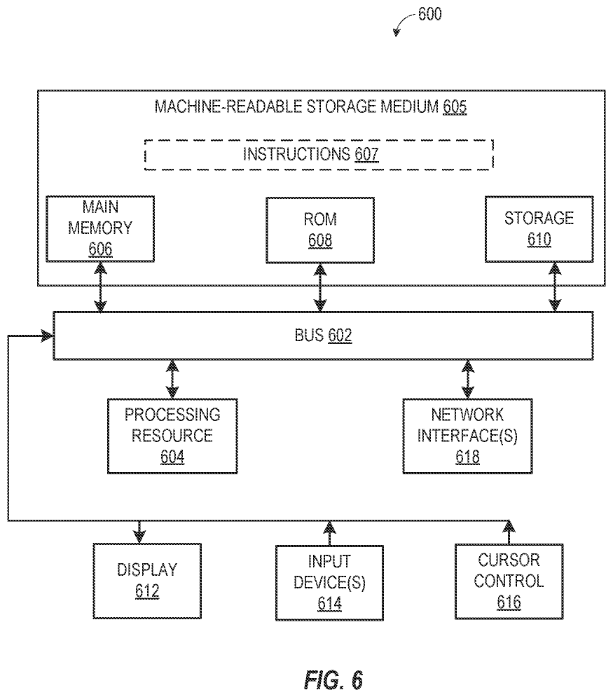

FIG. 6 depicts a block diagram of an example computing system 600 in which various of the examples described herein may be implemented. In one example, the computing system 600 may be configured to operate as a network device such as the network device 104 of FIG. 1, and can perform various operations described in one or more of the earlier drawings. In another example, the computing system 600 may be any system in a could infrastructure and capable of hosting a roaming management system described earlier. Examples of the devices and/or systems that may be implemented as the computing system 600 may include, desktop computers, laptop computers, servers, web servers, authentication servers, AAA servers, DNS servers, DHCP servers, IP servers, VPN servers, network policy servers, mainframes, tablet computers, e-readers, netbook computers, televisions and similar monitors (e.g., smart TVs), content receivers, set-top boxes, PDAs, mobile phones, smartphones, smart terminals, dumb terminals, virtual terminals, video game consoles, virtual assistants, loT devices, and the like.

The computing system 600 may include a bus 602 or other communication mechanisms for communicating information, a hardware processor, also referred to as processing resource 604, and a machine-readable storage medium 605 coupled to the bus 602 for processing information. In some examples, the processing resource 604 may include one or more CPUs, semiconductor-based microprocessors, and/or other hardware devices suitable for retrieval and execution of instructions stored in the machine-readable storage medium 605. The processing resource 604 may fetch, decode, and execute instructions to configure MLO for SSIDs. As an alternative or in addition to retrieving and executing instructions, the processing resource 604 may include one or more electronic circuits that include electronic components for performing the functionality of one or more instructions, such as an FPGA, an ASIC, or other electronic circuits.

In some examples, the machine-readable storage medium 605 may include a main memory 606, such as a RAM, cache and/or other dynamic storage devices, coupled to the bus 602 for storing information and instructions to be executed by the processing resource 604. The main memory 606 may also be used for storing temporary variables or other intermediate information during the execution of instructions to be executed by the processing resource 604. Such instructions, when stored in storage media accessible to the processing resource 604, render the computing system 600 into a special-purpose machine that is customized to perform the operations specified in the instructions. The machine-readable storage medium 605 may further include a read-only memory (ROM) 608 or other static storage device coupled to the bus 602 for storing static information and instructions for the processing resource 604. Further, in the machine-readable storage medium 605, a storage device 610, such as a magnetic disk, optical disk, or USB thumb drive (Flash drive), etc., may be provided and coupled to the bus 602 for storing information and instructions.

In some examples, the bus 602 of the computing system 600 may be coupled to a display 612, such as a liquid crystal display (LCD) (or touch-sensitive screen), for displaying information to a computer user. In some examples, an input device 614, including alphanumeric and other keys (physical or software generated and displayed on a touch-sensitive screen), may be coupled to the bus 602 for communicating information and command selections to the processing resource 604. Also, in some examples, another type of user input device such as a cursor control 616 may be connected to the bus 602. The cursor control 616 may be a mouse, a trackball, or cursor direction keys. The cursor control 616 may communicate direction information and command selections to the processing resource 604 for controlling cursor movement on the display 612. In some other examples, the same direction information and command selections as cursor control may be implemented via receiving touches on a touch screen without a cursor.

In some examples, the computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 600 also includes a network interface 618 coupled to bus 602. The network interface 618 provides a two-way data communication coupling to one or more network links that are connected to one or more local networks. For example, the network interface 618 may be an integrated services digital network (ISDN) card, cable modem, satellite modem, or a modem to provide a data communication connection to a corresponding type of telephone line. As another example, the network interface 618 may be a local area network (LAN) card or a wireless communication unit (e.g., Wi-Fi chip/module).

In some examples, the machine-readable storage medium 605 (e.g., one or more of the main memory 606, the ROM 608, or the storage device 610) stores instructions 607 (marked with dashed outline) which when executed by the processing resource 604 may cause the processing resource 604 to execute one or more of the methods/operations described hereinabove. The instructions 607 may be stored on any of the main memory 606, the ROM 608, or the storage device 610. In some examples, the instructions 607 may be distributed across one or more of the main memory 606, the ROM 608, or the storage device 610. In some examples, the instructions 607 when executed by the processing resource 604 may cause the processing resource 604 to perform one or more of the methods described in any of FIGS. 4 and 5.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

What is claimed is:

1. A method comprising:
accessing, by a network device, a machine learning (ML) model built based on a dataset characterizing past roaming of client devices among access points (APs) in a network infrastructure;
identifying, by the network device using the ML model, a first set of roaming targets comprising one or more non-radiofrequency (RF) neighbor access points (APs) corresponding to a source AP of a client device in the network infrastructure;
determining, by the network device, first roaming provisioning credentials for the first set of roaming targets; and
transmitting, by the network device, the first roaming provisioning credentials to the first set of roaming targets in advance of the client device roaming to any of the first set of roaming targets.

2. The method of claim 1, wherein the dataset comprises information corresponding to a plurality of roaming events, wherein, for a given client device of the client devices, a roaming event specifies one or more of an identifier of a respective source AP, an identifier of a target AP, a timestamp of the roaming event, a Media Access Control (MAC) address of the given client device, or device type of the given client device.

3. The method of claim 1, further comprising:
extracting model features based on the dataset, wherein the model features comprise one or more of a first device identifier of a source AP, a second device identifier of a target AP, a roaming event time, a third device identifier of the client device, or a client device type; and
training the ML model using the dataset during a learning phase.

4. The method of claim 3, wherein the training the ML model comprises first finetuning model features during the learning phase.

5. The method of claim 4, wherein identifying the first set of roaming targets comprises inferring, during an inference phase, the one or more non-RF neighbor APs based on the time of the day and using the ML model.

6. The method of claim 5, further comprising second finetuning, by network device, the model features based on roaming events reported during the inference phase.

7. The method of claim 1, wherein the first roaming provisioning credentials corresponding to the client device comprise a target encryption key, and wherein determining the first roaming provisioning credentials corresponding to the client device comprises calculating the target encryption key for each of the first set of roaming targets based on a client encryption key corresponding to the client device and respective Basic Service Set Identifiers (BSSIDs) of the first set of roaming targets.

8. The method of claim 7, wherein the client encryption key is an R0 key and the target encryption key is an R1 key specified in the Institute of Electrical and Electronics Engineers (IEEE) 802.11r Specification.

9. The method of claim 1, further comprising:
identifying, by the network device, a second set of roaming targets comprising one or more RF neighbor APs of the source AP;
determining, by the network device, second roaming provisioning credentials for the second set of roaming targets; and
transmitting, by the network device, the second roaming provisioning credentials to the second set of roaming targets in advance of the client device roaming to any of the first set of roaming targets.

10. The method of claim 9, wherein identifying the second set of roaming targets comprises selecting one or more APs having Received Signal Strength Indicator (RSSI) values at the source AP greater than a threshold value as the second set of roaming targets.

11. A network device, comprising:
a machine-readable storage medium storing executable instructions; and
a processing resource coupled to the machine-readable storage medium and configured to execute one or more of the instructions to:
access a machine learning (ML) model built based on a dataset characterizing past roaming of client devices among access points (APs) in a network infrastructure;
identify, using the ML model, a first set of roaming targets comprising one or more non-radiofrequency (RF) neighbor access points (APs) corresponding to a source AP of a client device in the network infrastructure;
determine first roaming provisioning credentials for the first set of roaming targets; and
transmit the first roaming provisioning credentials to the first set of roaming targets in advance of the client device roaming to any of the first set of roaming targets.

12. The network device of claim 11, wherein the dataset comprises information corresponding to a plurality of roaming events, wherein, for a given client device of the client devices, a roaming event specifies one or more of an identifier of a respective source AP, an identifier of a respective target AP, a timestamp of the roaming event, a Media Access Control (MAC) address of the given client device, or device type of the given client device.

13. The network device of claim 12, wherein the processing resource is configured to execute one or more of the instructions to train the ML model using the dataset during a learning phase.

14. The network device of claim 13, wherein to train the ML model, the processing resource is configured to execute one or more of the instructions to first finetune model features derived based on the plurality of roaming events, wherein the model features comprise one or more of a first device identifier of the source AP, a second device identifier of a target AP, an event time, a third device identifier of the client device, or a client device type.

15. The network device of claim 14, wherein the processing resource is configured to execute one or more of the instructions to:
infer, during an inference phase, the one or more non-RF neighbor APs based on the time of the day and using the ML model; and
second finetune the model features based on roaming events reported during the inference phase.

16. The network device of claim 11, wherein the processing resource is configured to execute one or more of the instructions to:
identify a second set of roaming targets comprising one or more RF neighbor APs of the source AP;
determine second roaming provisioning credentials for the second set of roaming targets; and
transmit the second roaming provisioning credentials to the second set of roaming targets in advance of the client device roaming to any of the first set of roaming targets.

17. The network device of claim 16, wherein the processing resource is configured to execute one or more of the instructions to select one or more APs having Received Signal Strength Indicator (RSSI) values at the source AP greater than a threshold value as the second set of roaming targets.

18. A networked system comprising:
a plurality of access points (APs) comprising a source AP facilitating wireless connectivity to a client device in a network infrastructure; and
a network device communicatively coupled to the plurality of APs, wherein the network device is configured to:
access a machine learning (ML) model built based on a dataset characterizing past roaming of client devices among the plurality of APs in the network infrastructure;
identify, using the ML model, a first set of roaming targets comprising one or more non-radiofrequency (RF) neighbor APs corresponding to the source AP;
determine first roaming provisioning credentials for the first set of roaming targets; and
transmit the first roaming provisioning credentials to the first set of roaming targets in advance of the client device roaming to any of the first set of roaming targets,
wherein a roaming target of the first set of roaming targets authenticates the client device using a respective one of the first roaming provisioning credentials when the client device associates with the roaming target.

19. The networked system of claim 18, wherein the network device is configured to:
identify a second set of roaming targets comprising one or more RF neighbor APs of the source AP;
determine second roaming provisioning credentials for the second set of roaming targets; and
transmit the second roaming provisioning credentials to the second set of roaming targets in advance of the client device roaming to any of the first set of roaming targets.

20. The networked system of claim 18, wherein the network device is further configured to:
first finetune model features derived based on the dataset;
infer, during an inference phase, the one or more non-RF neighbor APs based on the time of the day and using the ML model; and
second finetune the model features based on roaming events reported during the inference phase.
